(19) United States
(12) Patent Application Publication
(10) Pub. No.: US 2002/0064413 A1
(43) Pub. Date: May 30, 2002

(54) Porous plastic articles and method of making the same

(76) Inventor: David Cowieson, Wrexham (GB)

Correspondence Address: NEEDLE & ROSENBERG, P.C., The Candler Building, Suite 1200, 127 Peachtree Street, N.E., Atlanta, GA, 30303-1811, US

(21) Appl. No.: 09/969,524

(22) Filed: Oct. 2, 2001

(30) Foreign Application Priority Data
Oct. 2, 2000 (GB) GB 0024046.5

(51) Int. Cl. B05C 11/00

(52) U.S. Cl. 401/266; 401/265

(57) ABSTRACT

A porous article and method of making a porous article suitable for allowing the passage and release of fluids/vapours/aerosols therethrough comprising the steps of: metering a predetermined amount of powder onto or into a first mould piece; introducing a second mould piece onto the powder so as to shape the powder into the desired shape of the finished article or using a combination of metered dosing and mould vibration to achieve greater control over the powder filling operation and final powder density; heating the powder to a sufficient temperature for sintering thereof to occur thus forming the porous article; and removing the article from the mould pieces.

This application claims priority to Great Britain Application GB 0024046.5 filed Oct. 2, 2000, which application is herein incorporated by reference in its entirety.

The present invention relates to a method of making porous articles. More particularly, the present invention relates to a method of making porous articles to be used in applying liquids and gels to solid surfaces or releasing vapours or liquids to the surrounding environments, that are manufactured using a sintering process.

A number of methods are known for applying liquid and semi-liquid products such as deodorant or skin-cream onto surfaces such as the skin from a dispenser. Where the product is sufficiently liquid a roll-on device may be employed. However, the rotating ball is liable to become jammed if the product dries on the ball. Furthermore, the use of a product with a sufficiently low viscosity for the roll-on device to function can often cause the product to have an undesirably long drying time. The use of foam applicator heads has also been proposed, but these have a tendency to become overloaded with product which then either dries, clogging the head or drips off the head, both of which are clearly undesirable.

In addition, devices releasing fragrance or other chemicals to the surrounding environment require large surface areas, good wicking properties and in some cases thin wall structures and low void volumes. Known porous structures can be difficult to fabricate with this combination of properties using traditional filling technology.

Traditional in line sequential sintering process is operated with a multiplicity of moulds that require frequent cleaning due to spillage and excess powder retained on the exterior surfaces of the mould.

Porous articles manufactured according to the present invention seek to overcome, or at least mitigate the problems of the prior art.

One aspect of the present invention provides a method of making a porous article suitable for allowing the passage and release of fluids/vapours/aerosols therethrough which may comprise the steps of: i) accurately metering a predetermined amount of powder onto or into a first mould piece; ii) introducing a second mould piece onto the powder so as to shape the powder into the desired shape of the finished article; iii) heating the powder to a sufficient temperature for sintering thereof to occur thus forming the porous article; and iv) removing the article from the mould pieces.

Preferably the introduction of the second mould piece may additionally compact the powder and modify the surface finish where appropriate.

According to an optional feature of this aspect of the present invention the powder may be introduced into a substantially central portion of the first mould piece to assist shaping the powder into the mould form.

A second aspect of the present invention provides a method of making a porous article suitable for allowing the passage and release of fluids/vapours/aerosols therethrough comprising the steps of: i) filling a mould cavity formed by first and second mould pieces with powder; ii) heating the powder to a sufficient temperature for sintering thereof to occur, thus forming the porous article; and iii) removing the article from the mould pieces.

According to an optional feature of either aspect of the invention the first and/or second mould piece may vibrate and/or rotate to assist in the distribution of the power throughout the mould cavity during and after the filling operation. This combination of mould vibration and powder flow allows more control over the speed of the filling process and final packing density of the powder within the mould.

According to a second optional feature of either aspect of the invention the particles comprising the powder may have a substantially smooth surface finish. Alternatively the powder may have an uneven surface finish.

According to a fourth optional feature of either aspect of the invention the powder may be a thermoforming polymer.

According to a fifth optional feature of either aspect of the invention the powder may be sintered at a temperature just below the melting point of the polymer. Preferably, the polymer may be polyethylene, polyproplylene, PVC, PTFE, PVDF or Nylon. More preferably, the polymer may be polyethylene, polyproplene or PVC. Even more preferably the powder may be sintered for a period of between 4 minutes and 20 minutes. Yet more preferably the powder may be sintered in an oven and the oven may be heated to a temperature of 180°-200° C. Even more preferably the powder may be sintered for a period of between 5 minutes and 10 minutes. The invention relates to a porous article made by a method referred to in the preceding paragraphs.

A third aspect of the present invention relates to a dispenser for dispensing a fluid comprising a container and a porous plastics article secured to the container and suitable for allowing the passage of fluid therethrough. Preferably, the porous plastics article may be formed by a sintering process. More preferably, the porous plastics article may be made from a polymer for example polyethylene, polyproplylene, PVC, PTFE, PVDF or nylon.

Exemplary embodiments of the invention are further described, by way of example only, with reference to the accompanying drawings in which:

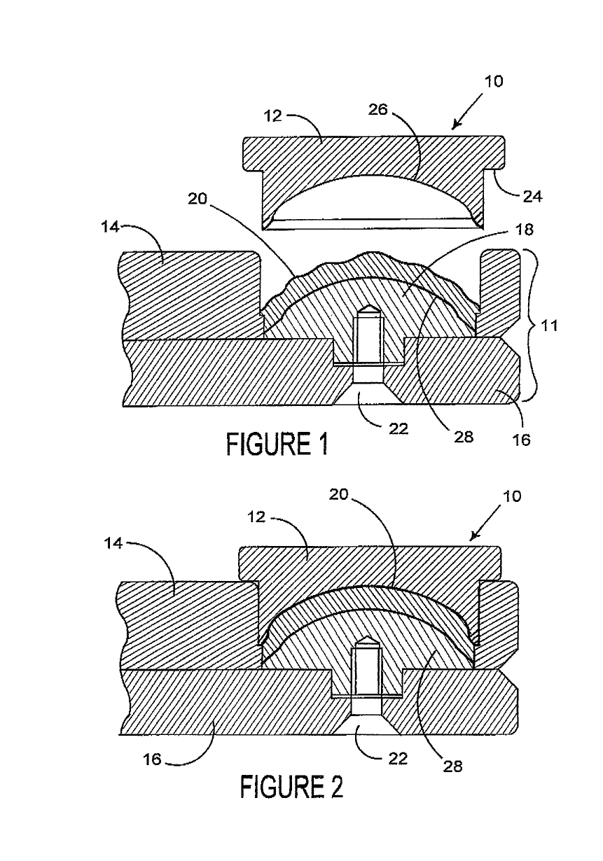

FIG. 1 is a cross-sectional view through the mould with the powder in situ prior to the shaping thereof;

FIG. 2 is a cross-sectional view of the mould in which the powder has been shaped by the introduction of a second mould piece;

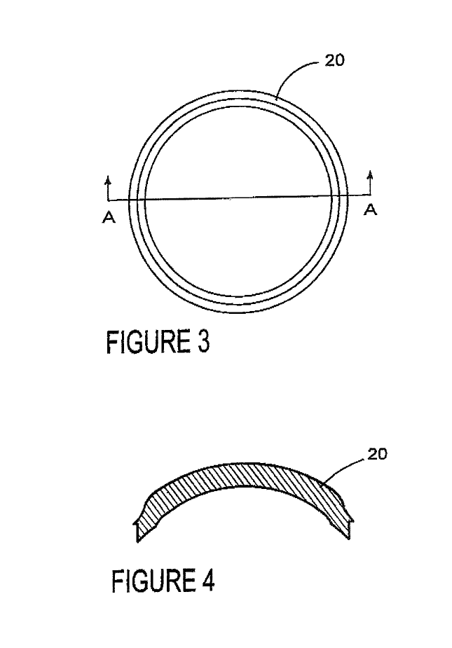

FIG. 3 is a plan view of the finished article formed from the powder; and

FIG. 4 is a cross-sectional view of the finished article in the axis A-A.

Referring to FIG. 1, there is shown a mould 10 comprising a first mould piece 11 and a second mould piece 12. In this embodiment, the first mould piece 11 is constructed from a plurality of separate components to enable it to be adapted quickly for the manufacture of a variety of different porous articles and be dismantled for periodic cleaning. More specifically, the first mould piece 11 comprises, in this embodiment, a base 16, a side portion 14 and an interchangeable core piece 18. In order that the core 18 may be interchanged, the core 18 is advantageously releasably mounted on a base by means of screw 22 or other suitable fasteners such as a known clip arrangement, for example.

A predetermined volume of powder 20 is placed on the surface 28 of core 18. It is preferable that the powder 20 is metered to within +/−5% of the desired mass, more preferably +/−1%. Dependant upon the flow characteristics of the powder 20 and the shape of the core piece surface 28, it may be distributed over the entire surface of the core 28 as illustrated in FIG. 1, or be placed in a substantially central location thereon. The volume of powder 20 placed on the core 18 can be varied according to the amount of compaction of the powder 20 that is desired in order to achieve the required article shape (which is of fixed volume). The more powder that is used, the greater the compression required and hence the lower the porosity of the finished article.

In certain classes of embodiment, consolidation of the powder may be achieved by either rotating or vibrating the mould during and after the filling process. These processes advantageously also ensure that the powder is evenly distributed throughout the mould cavity particularly where it has a thin section.

The shape of the particles that comprise the powder 20 also influences the properties of the finished article. The use of substantially spherical particles generally results in a relatively freely flowing powder and a finished article having a smoother surface and more open pore structure. Clearly, a smooth article surface is desirable if the article is to be used in applying substances to the skin, but the free-flowing nature means it is difficult to manufacture articles having a higher, steeper profile.

Alternatively, if unevenly shaped or dendritic particles are used, the powder flows less freely, and can be used for producing steeper profiled particles more easily, for example where a dome type profile is required. Compaction and/or consolidation of the powder can be achieved to a greater or lesser degree than for spherical powders, particularly if mould vibration is employed during and/or after the filling operation. Beneficially, better wicking will be achieved through the article and the void volume can be adjusted over a wider range by using unevenly shaped particles. However, the surface of the finished article is generally less smooth.

Particle shape, size and size distribution are all important in determining the pore structure and surface finish of an article. Compaction can also be important for surface finish and can influence porosity at or near the surface. Where surface finish is critical to an article, compaction can be used to modify this property while using particle size, shape and size distribution and mould vibration to control the pore structure.

Suitable powders that may be used may be manufactured from thermoforming polymers such as polyethylene, polyproplylene, polyrinylchloride (PVC), polytetrafluoroethylene (PTFE), polyvinyldifluoride (PVDF) and Nylon. In a preferred embodiment of the invention polyethylene, polyproplylene or PVC is used. In a particularly preferred embodiment, polyethylene is used.

The next stage of the process is to place a second mould portion 12 onto the powder as illustrated in FIG. 2. In this embodiment, the second mould portion however comprises a lip 24 arranged to engage the side wall 14, thereby ensuring that the correct size of article is produced, and that the correct amount of compaction of the powder (if any) is attained. Furthermore, the second mould piece has a female mould surface 26 that ensures the powder 20 is distributed evenly and forms the shaped outer surface of the finished article.

Once the shape of the article has been formed as illustrated in FIG. 2, the powder is heated to just below the melting point for the powder to achieve sintering of the particles. The particles may be heated by providing elements with the mould pieces (not shown) or by placing the pieces in a suitable oven. At this temperature the surfaces of the particles are sufficiently hot to melt the surfaces of adjoining particles but the temperature is not sufficient for the powder to melt entirely. If the preferred powders are heated in an oven, the powders are sintered for a period of between 1 and 20 minutes. The optimum sintering period has been found to be 5 to 10 minutes at an oven temperature of between 130° and 200° C. when polyethylene powder has been used. Therefore, once the powder has cooled, the individual particles have mutually adhered with pores remaining therebetween.

It is envisaged that the method could be mechanised so as to operate as a continuous process using a plurality of moulds.

Once the article 20 has cooled sufficiently it is removed from the mould 10. It can be seen from FIGS. 3 and 4 that in this embodiment, a circular domed article has been formed that is suitable for use as an applicator portion of a formulation dispenser/emanator or similar, fluid wick or filter. Of course, other shapes and sizes of article are envisaged by using different mould elements. Furthermore, the density of the porous article can be adjusted according to the size of particles, shape, for example, dendritic (will increase porosity and reduce density) or smooth (will increase density), or amount of compaction so that the mechanical strength can be adjusted according to the particular use. Similarly, the porosity is adjusted by changing the same parameters to change the fluid flow parameters through the porous article.

In a second embodiment of the present invention (not shown), the mould shapes are inverted such that the peripheral edge of a domed article thereby produced is uppermost. The two mould pieces are placed in the required spaced relationship for forming the finished article prior to the introduction of the powder.

The powder is introduced from the edge of the mould cavity, which is left at least partially open for this purpose. The powder then flows under the influence of gravity to fill the mould cavity. It is preferable that relatively freely flowing powder is used for this purpose, however the moulds could be vibrated to ensure that the cavity is completely filled if less freely flowing powder is used or the shape of the mould cavity does not lend itself to filling under gravity. Vibration may also be used if consolidation of the powder is required.

This method reduces the need for accurate powder metering and can be used for article shapes that cannot be made in the upright position. However, it is more difficult to control powder compaction on the upper surface of the article. Compaction may however be achieved by placing the two mould pieces in a first spaced position, filling the mould cavity with powder, as above, and then applying a load to the mould pieces so as to bring the mould pieces into a second, closer spaced position that corresponds to the required thickness of the finished article however the degree of compaction is likely to be greater and it will begin to affect the body of the article as well as it's surfaces The powder may then be sintered as in the first embodiment.

The porous article made from the method described above can be used in a dispenser whereby it is secured to a container by known securing means for example glue or mechanical fixing and the container containing a fluid, vapour or fragrence.

It is envisaged that a wide variety of articles could be formed using this process for a number of different applications. For example, articles could be formed for use in dispensing insect repellents, suntan lotions or other skin creams. Additionally, the articles could be incorporated into a fragrance dispenser in which liquid fragrance is sprayed or wicked into the porous structure, which would then be released into a room as vapour. The rate of release can then be adjusted by the consumer. Spraying from a squeezable bottle or pressurised container would then allow the consumer more control over the rate of release.

1. A method of making a porous article suitable for allowing the passage and release of fluids/vapours/aerosols therethrough comprising the steps of:
i) accurately metering a predetermined amount of powder onto or into a first mould piece;
ii) introducing a second mould piece onto the powder so as to shape the powder into the desired shape of the finished article;
iii) heating the powder to a sufficient temperature for sintering thereof to occur thus forming the porous article; and
iv) removing the article from the mould pieces.

2. A method according to claim 1 wherein the introduction of the second mould piece additionally compacts the powder.

3. A method according to claim 1 wherein the powder is introduced into a substantially central portion of the first mould piece to achieve the desired shape.

4. A method according to claim 2 wherein the powder is introduced into a substantially central portion of the first mould piece to achieve the desired shape.

5. A method according to claim 1 wherein the first and/or second mould piece may vibrate and/or rotate to assist in the distribution of the power throughout the mould cavity and increase control over the packing density of the powder.

6. A method according to claim 1 wherein the particles comprising the powder have a substantially smooth surface finish.

7. A method according to claim 1 wherein the particles comprising the powder have an uneven surface finish.

8. A method according to claim 6 wherein the powder is a thermoforming polymer.

9. A method according to claim 6 wherein the powder is sintered at a temperature just below the melting point of the polymer.

10. A method according to claim 9 wherein the polymer is polyethylene, polyproplylene, PVC, PTFE, PVDF or nylon.

11. A method according to claim 10 wherein the polymer is polyethylene, polyproplene or PVC.

12. A method according to claim 11 wherein the powder is sintered for a period of between 1 minute and 20 minutes.

13. A method according to claim 12 wherein the powder is sintered in an oven and the oven is heated to a temperature of 130°-200° C.

14. A method according to claim 13 wherein the powder is sintered for a period of between 5 minutes and 10 minutes.

15. A method of making a porous article suitable for allowing the passage of fluids/vapours/aerosols therethrough comprising the steps of:
i) filling a mould cavity formed by first and second mould pieces with powder;
ii) heating the powder to a sufficient temperature for sintering thereof to occur, thus forming the porous article; and
iii) removing the article from the mould pieces.

16. A method according to claim 15 wherein the first and/or second mould piece may vibrate and/or rotate to assist in the distribution of the power throughout the mould cavity and increase control over the packing density of the powder.

17. A method according to claim 15 wherein the particles comprising the powder have a substantially smooth surface finish.

18. A method according to claim 15 wherein the particles comprising the powder have an uneven surface finish.

19. A method according to claim 17 wherein the powder is a thermoforming polymer.

20. A method according to claim 17 wherein the powder is sintered at a temperature just below the melting point of the polymer.

21. A method according to claim 20 wherein the polymer is polyethylene, polyproplylene, PVC, PTFE, PVDF or nylon.

22. A method according to claim 21 wherein the polymer is polyethylene, polyproplene or PVC.

23. A method according to claim 22 wherein the powder is sintered for a period of between 1 minute and 20 minutes.

24. A method according to claim 23 wherein the powder is sintered in an oven and the oven is heated to a temperature of 130°-200° C.

25. A method according to claim 24 wherein the powder is sintered for a period of between 5 minutes and 10 minutes.

26. A porous article manufactured by a method comprising the steps of:
i) accurately metering a predetermined amount of powder onto or into a first mould piece;
ii) introducing a second mould piece onto the powder so as to shape the powder into the desired shape of the finished article;
iii) heating the powder to a sufficient temperature for sintering thereof to occur thus forming the porous article; and
iv) removing the article from the mould pieces.

27. A porous article manufactured by a method comprising the steps of:
i) filling a mould cavity formed by first and second mould pieces with powder;
ii) heating the powder to a sufficient temperature for sintering thereof to occur, thus forming the porous article; and
iii) removing the article from the mould pieces.

28. A dispenser for dispensing a fluid comprising a container and a porous plastics article secured to the container and suitable for allowing the passage of fluid therethrough.

29. A dispenser as claimed in claim 28 wherein the porous plastics article is formed by a sintering process.

30. A dispenser as claimed in claim 29 wherein the porous plastics article is made from a polymer for example polyethylene, polyproplylene, PVC, PTFE, PVDF or nylon.
